(19) United States
(12) Patent Application Publication
(10) Pub. No.: US 2022/0405659 A1
(43) Pub. Date: Dec. 22, 2022

(54) DATA-DRIVEN AUTOMATED MODEL IMPACT ANALYSIS

(71) Applicant: International Business Machines Corporation, Armonk, NY (US)

(72) Inventors: Srinivasan S. Muthuswamy, Bangalore (IN); Subhendu Das, Chapel Hill, NC (US); Mukesh Kumar, Bangalore (IN); Willie Robert Patten, JR., Hurdle Mills, NC (US)

(21) Appl. No.: 17/349,882

(22) Filed: Jun. 16, 2021

(51) Int. Cl. G06Q 10/06; G06N 20/00; G06Q 40/08; G06Q 20/40

(52) U.S. Cl. CPC G06Q 10/0635; G06N 20/00; G06Q 40/08; G06Q 20/4016

(57) ABSTRACT

Embodiments relate to a system, program product, and method for automatically executing an impact analysis of a data analytics pipeline to determine impacts to the pipeline subject to changes to input data and the pipeline. The method includes determining, automatically, components of the pipeline that are impacted by the implemented changes. The method also includes identifying datasets to rescore through the pipeline. Each of the datasets to rescore have been scored through the pipeline prior to the changes such that previous scores of each of the respective datasets have been determined by the pipeline prior to the changes. The method further includes rerunning, through only the determined impacted components, the datasets, thereby generating rescores of the datasets. The method also includes retrieving each of the previous scores of the datasets, comparing the rescores with the respective previous scores, and transmitting, subject to the comparing, alerts to an output device.

### BACKGROUND

The present disclosure relates to data analytics pipelines, and, more specifically, to automatically executing an impact analysis of a data analytics pipeline to determine impacts to the pipeline subject to changes to one or more of input data and the pipeline.

Many known fraud detection pipelines are configured to receive data and process the data through a data analytics pipeline that includes components such as filters, transform functions, and models to analyze the data to determine potential fraudulent transactions, e.g., for banking institutions (e.g., transactions) and insurance institutions (e.g., claims).

### SUMMARY

A system, computer program product, and method are provided for automatically executing an impact analysis of a data analytics pipeline to determine impacts to the pipeline subject to changes to one or more of input data and the pipeline.

In one aspect, a computer system is provided for automatically executing an impact analysis of a data analytics pipeline to determine impacts to the data analytics pipeline subject to changes to one or more of input data and the data analytics pipeline. The system includes one or more processing devices and one or more memory devices communicatively and operably coupled to the one or more processing devices. The system also includes a pipeline impact tool at least partially embedded within the one or more memory devices. The pipeline impact tool is configured to determine, automatically, one or more components of the data analytics pipeline that are impacted by the one or more implemented changes. The pipeline impact tool is also configured to identify one or more datasets to rescore through the data analytics pipeline. Each of the one or more datasets to rescore have been scored through the data analytics pipeline prior to the one or more implemented changes such that one or more previous scores of each of the one or more respective datasets have been determined by the data analytics pipeline prior to the one or more implemented changes. The pipeline impact tool is further configured to rerun, through only the determined one or more impacted components of the data analytics pipeline, the one or more datasets, thereby generating one or more rescores of the one or more dataset. The pipeline impact tool is further configured to retrieve each of the one or more previous scores of the one or more datasets, compare the one or more rescores with the respective one or more previous scores, and transmit, subject to the comparison, one or more alerts to an output device.

In another aspect, a computer program product embodied on at least one computer readable storage medium having computer executable instructions for automatically executing an impact analysis of a data analytics pipeline to determine impacts to the pipeline subject to changes to one or more of input data and the pipeline that when executed cause one or more computing devices to determine, automatically, one or more components of the data analytics pipeline that are impacted by the one or more implemented changes; identify one or more datasets to rescore through the data analytics pipeline, where each of the one or more datasets to rescore have been scored through the data analytics pipeline prior to the one or more implemented changes such that one or more previous scores of each of the one or more respective datasets have been determined by the data analytics pipeline prior to the one or more implemented changes; rerun, through only the determined one or more impacted components of the data analytics pipeline, the one or more datasets, thereby generating one or more rescores of the one or more datasets; retrieve each of the one or more previous scores of the one or more datasets; compare the one or more rescores with the respective one or more previous scores; and transmit, subject to the comparison, one or more alerts to an output device.

In yet another aspect, a computer-implemented method is provided for automatically executing an impact analysis of a data analytics pipeline to determine impacts to the pipeline subject to changes to one or more of input data and the pipeline. The method includes determining, automatically, one or more components of the data analytics pipeline that are impacted by the one or more implemented changes. The method also includes identifying one or more datasets to rescore through the data analytics pipeline. Each of the one or more datasets to rescore have been scored through the data analytics pipeline prior to the one or more implemented changes such that one or more previous scores of each of the one or more respective datasets have been determined by the data analytics pipeline prior to the one or more implemented changes. The method further includes rerunning, through only the determined one or more impacted components of the data analytics pipeline, the one or more datasets, thereby generating one or more rescores of the one or more datasets. The method also includes retrieving each of the one or more previous scores of the one or more datasets, comparing the one or more rescores with the respective one or more previous scores, and transmitting, subject to the comparing, one or more alerts to an output device.

The present Summary is not intended to illustrate each aspect of, every implementation of, and/or every embodiment of the present disclosure. These and other features and advantages will become apparent from the following detailed description of the present embodiment(s), taken in conjunction with the accompanying drawings.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are illustrative of certain embodiments and do not limit the disclosure.

FIG. 1 is a block schematic diagram illustrating a computer system configured for automatically executing an impact analysis of a data analytics pipeline to determine impacts to the pipeline subject to changes to one or more of input data and the pipeline, in accordance with some embodiments of the present disclosure.

FIG. 2 is a block schematic diagram illustrating the relationships between the inputs to a pipeline impact tool, the tool, and the outputs of the tool, in accordance with some embodiments of the present disclosure.

FIG. 3 is a block schematic diagram illustrating a data analytics pipeline, in accordance with some embodiments of the present disclosure.

FIG. 4A is a flowchart illustrating a process for automatically executing an impact analysis of a data analytics pipeline to determine impacts to the pipeline subject to changes to one or more of input data and the pipeline, in accordance with some embodiments of the present disclosure.

FIG. 4B is a continuation of the flowchart illustrated in FIG. 4A, in accordance with some embodiments of the present disclosure.

FIG. 4C is a continuation of the flowchart illustrated in FIG. 4B, in accordance with some embodiments of the present disclosure.

FIG. 5 is a block schematic diagram illustrating a computing system, in accordance with some embodiments of the present disclosure.

FIG. 6 is a schematic diagram illustrating a cloud computing environment, in accordance with some embodiments of the present disclosure.

FIG. 7 is a schematic diagram illustrating a set of functional abstraction model layers provided by the cloud computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure relate to automatically executing an impact analysis of a data analytics pipeline to determine impacts to the pipeline subject to changes to one or more of input data and the pipeline. While the present disclosure is not necessarily limited to such applications, various aspects of the disclosure may be appreciated through a discussion of various examples using this context.

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “at least one embodiment,” “one embodiment,” “another embodiment,” “other embodiments,” or “an embodiment” and similar language means that a particular feature, structure, or characteristic described in connection with the embodiment is included in at least one embodiment. Thus, appearances of the phrases “a select embodiment,” “at least one embodiment,” “in one embodiment,” “another embodiment,” “other embodiments,” or “an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Many known data analytic pipelines include fraud detection pipelines that are configured to receive data and process the data through a data analytics pipeline that includes components such as filters, transform functions, and models to analyze the data to determine potential fraudulent transactions, e.g., for banking institutions (e.g., transactions) and insurance institutions (e.g., claims). In at least some fraud detection scenarios, a given model may be determined to be underperforming, or a particular feature of the data analytics may have lapses. In some instances, additional data that alters an existing database schema in the fraud detection pipeline may be input. Additionally, in some instances, existing data may be altered due to changing circumstances with particular cases. Upon any adjustments made to the structure of the fraud detection pipeline due to corrections of the aforementioned lapses or the new or updated data, a select set of cases are rerun through the fraud detection pipeline to determine that the revised results are obtained. Typically, the analytic processes of the fraud detection pipelines are time-consuming and an extensive amount of time, up to 12 to 14 hours, may be required to rerun the entire pipeline process if one or more of the software artifacts within the pipeline are impacted.

In at least some known fraud detection pipelines, a particular file with specific case data is input into the pipeline to be analyzed for potentially fraudulent claims. For example, a particular insurance claim file for an individual includes a number of vehicular accidents reported for claims over a relatively short period of time. The fraud detection pipeline will analyze the data and through the use of one or more models previously placed into production will score the claims individually, and in some cases, the suite of claims as a whole. Based on comparisons of the present claim data with the model that is trained to recognize certain patterns, a determination will be made with respect to whether any of the claims and the respective behaviors of the affected parties, including the individual and repair facilities, are indicative of fraudulent behavior and/or fraudulent claim reporting. In general, the results of the analysis will be in the form of a probability with a confidence factor directed toward any potentially fraudulent behaviors detected. Similar fraud detection pipelines such as those found in the insurance domain may also be found in the banking domain to determine if particular financial transactions are being executed through shell corporations that have been flagged for further scrutiny, or if such transactions may be indicative of money laundering activities.

In many of these fraud detection pipelines, regardless of the domain they are designed, include any necessary data input be ingested by the pipeline in a particular format that corresponds to an associated database schema developed for the particular pipeline. For example, each particular column of a database used as the data input may be reserved for particular pieces of data, e.g., vehicular repairs including the repair facilitates, damage repairs, and attendant costs. Further, for example, the pipeline already in service may be scheduled for addition of another to the existing columns, e.g., a new column for photographic image data of vehicles in a before-repair condition and an after-repair condition. Most known pipelines will be removed from service to undergo any required upgrading to accept the additional data and subsequent to the upgrades, a select group of cases will be rerun through the pipeline to retrain the models and to provide some degree of assurance to the users of the pipeline that the additional data does not corrupt the outputs of the pipeline, where at least a portion of such assurance may be obtained through comparison of the new outputs with previous outputs for the respective cases. These cases may include existing cases that have already been analyzed; however, to meet the new requirements, these existing cases will be reanalyzed by running the previous data through the pipeline with the new data (e.g., the image data). As previously described, such rerunning of the cases through the pipeline could take up to 12 to 14 hours, and there are rarely any shortcuts that can be applied to drastically reduce the time requirements. In addition, if the rerunning of the data generates wildly divergent analysis results, extensive investigation may be required to determine the exact point of the process where the discrepancies originate.

A system, computer program product, and method are disclosed and described herein for automatically executing an impact analysis of a data analytics pipeline to determine impacts to the pipeline subject to changes to one or more of input data and the pipeline. More specifically, the system, computer program product, and method are configured for determining those portions of a data pipeline impacted by changes to the configuration of other attributes of the input data, as well as changes or additions to existing data within the associated database. For example, and without limitation, additional data may affect one or more of the filters, transforms, and models (all discussed further herein) used within the respective data pipeline while not affecting other similar software artifacts within the pipeline. The system is configured to identify only those software components in the pipeline that are impacted so that any remedial action to resolve data processing changes that need to be implemented and tested may be specifically targeted toward those impacted software artifacts, thereby significantly decreasing the time period and the resources (human and otherwise) to identify and resolve issues through extensive rerunning of data (e.g., in the form of cases as previously described herein). In some embodiments, at least a portion of the models are arranged in a hierarchical configuration such that some of the models may be impacted, and some models not impacted; however, some of those impacted models in a lower tier of the hierarchy are data inputs to one or more models in an upper tier. Therefore, all of the components, including the models, whether directly impacted by the changes or indirectly impacted due to a relationship with the directly impacted components will automatically be identified as impacted components.

In addition, the system is configured to automatically identify the necessary remedial actions to update at least some of the impacted components appropriately, including retraining the impacted models, and inform the users of the results of the analyses and upgrades. Moreover, the embodiments described herein are configured to automatically trigger retraining of the impacted models in the retrain mode through using the outputs of the other impacted pipeline components as well as the previous results for those pipeline components not impacted by the changes. The retrained model will be maintained until it is placed into productions. Therefore, only those portions of the pipeline that are impacted by the changes to the data need to operationally retested and verified. As described herein, the exemplary embodiments are directed toward fraud detection pipelines; however, the systems described herein may be implemented in any data pipelines in any domain.

Accordingly, as described further herein, the disclosed system, computer program product, and method are configured to perform impact analyses to determine which stream of the fraud analytics pipeline are impacted by changes to the pipeline or the data ingested therein. In addition, the disclosed system, computer program product, and method are configured to optimally only rerun those impacted tasks through the pipeline and execute the fraud detection pipeline for the impacted cases in the rerun mode, allowing only the impacted steps to be re-executed, where the non-impacted steps are re-used from the history run. Moreover, the disclosed system, computer program product, and method are configured to identify the alerts and the cases which are likely to be impacted of this change.

In the embodiments described herein, as described above, the fraud analytics pipelines only rerun those select tasks that are determined to be impacted by the data changes. For example, and without limitation, the embodiments herein determine whether or not one or more models associated with the subject pipeline need a retraining, or whether or not one or more models associated with the subject pipeline need to be used to rescore the data subsequent to the changes to the database schema or the data therein. Such features as described herein facilitate a significant decrease from the 12-14 hours to completely rerun the data through the pipeline through identifying only those select tasks to rerun. In addition, focusing on only those pipeline components that may be impacted facilitates a more rapid conclusion by the system that none of the components, including the models, are impacted and no rescoring or retraining need be performed.

More specifically, the embodiments disclosed herein take into account the integrated existing complexity of the data, data transform functions, model training, scoring by the models, code changes, data and pipeline configuration changes, and the ability to rescore the past runs of the data through the pipeline by rerunning only those selective tasks impacted by the aforementioned changes. Again, for example, and without limitation, for those situations where there is a change to the model input, the impacted model will need to be retrained, and a selected number of claims will need to be rescored through the updated model. For example, and without limitation, it may be determined that rescoring the claims of the most recent calendar week will satisfy the rescoring requirement. Here, the data for the previous week's claims do not need to be rerun again through the entire pipeline which would take approximately 12-14 hours for each day's worth of claim data. Rather, in contrast to known data analytics pipelines, only those impacted steps need to be rerun to rescore the last 7 days of claim data. In addition, if the rescoring results are substantially similar to the previous scores, the embodiments disclosed herein “understand” that the change in the incoming features do not impact the model output, and hence the dependent tasks of the model are skipped as they are determined to not cause any impact to the pipeline. Moreover, regardless of the change, i.e., whether to the data, the code, the model, the data configuration, or pipeline configuration, the embodiments disclosed herein dynamically evaluate all aspects of the pipeline and determine those aspects of the pipeline that are impacted. Therefore, in light of the dynamic interactive features of the pipeline, the embodiments described herein will only rerun the select set of tasks for any given changes, thereby facilitating a significant reduction in the amount of time and resources needed to restore the pipeline to full functional capacity as intended by the users. Accordingly, the embodiments described herein define data-driven automated model impact analyses.

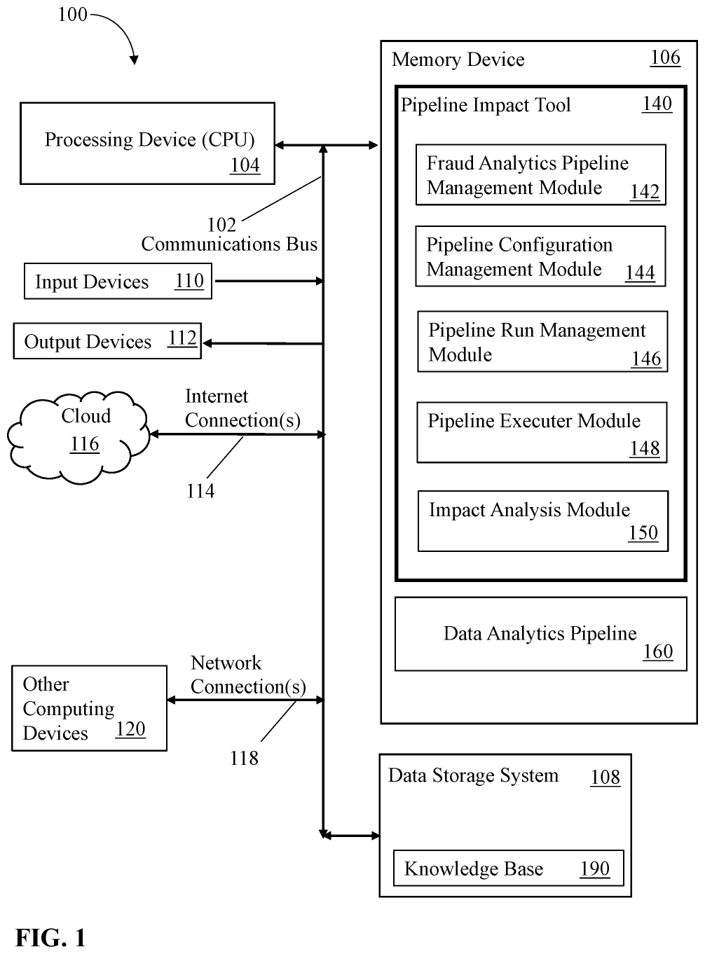

Referring to FIG. 1, a block schematic diagram is provided illustrating a computer system, i.e., a data analytics pipeline management system 100 (herein referred to as “the system 100”) that is configured for automatically executing an impact analysis of a data analytics pipeline to determine impacts to the pipeline subject to changes to one or more of the input data and the pipeline, in accordance with some embodiments of the present disclosure. More specifically, the system 100 is configured for determining those portions of a data pipeline impacted by changes to the configuration of other attributes of the input data, as well as changes or additions to existing data within the associated database. For example, and without limitation, additional data may affect one or more of the filters, transforms, and models (all discussed further herein) used within the respective data pipeline while not affecting other similar software artifacts within the pipeline. The system 100 is configured to identify only those software components in the pipeline that are impacted so that any remedial action to resolve data processing changes that need to be implemented and tested may be specifically targeted toward those impacted software artifacts, thereby significantly decreasing the time period and the resources (human and otherwise) to identify and resolve issues through extensive rerunning of data (e.g., in the form of cases as previously described herein). In addition, the system 100 is configured to automatically take the necessary remedial actions to update the impacted components appropriately, generate the revised software artifacts, including the impacted models, inform the users of the results of the analyses and upgrades, and store the upgraded software artifacts until the user places them into production in the pipeline. Therefore, only those portions of the pipeline that are impacted by the changes to the data need to operationally retested and verified. As described herein, the exemplary embodiments are directed toward fraud detection pipelines; however, the data pipeline management systems 100 described herein may be implemented in any data pipelines in any domain.

The system 100 includes one or more processing devices 104 (only one shown) communicatively and operably coupled to one or more memory devices 106 (only one shown). In some embodiments, the processing device 104 is a multicore processing device. The system 100 also includes a data storage system 108 that is communicatively coupled to the processing device 104 and memory device 106 through a communications bus 102. The system 100 further includes one or more input devices 110 and one or more output devices 112 communicatively coupled to the communications bus 102. In addition, the system 100 includes one or more Internet connections 114 (only one shown) communicatively coupled to the cloud 116 through the communications bus 102, and one or more network connections 118 (only one shown) communicatively coupled to one or more other computing devices 120 through the communications bus 102. In some embodiments, the Internet connections 114 facilitate communication between the system 100 and one or more cloud-based centralized systems and/or services (not shown in FIG. 1).

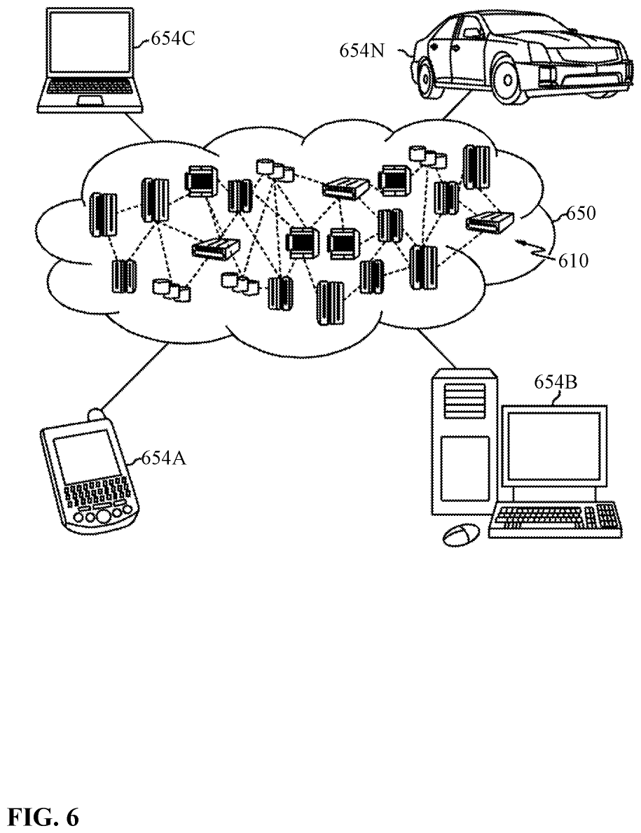

In at least some embodiments, the system 100 is a portion of a cloud computing environment (see FIG. 6), e.g., and without limitation, system 100 is a computer system/server that may be used as a portion of a cloud-based systems and communications environment through the cloud 116 and the Internet connections 114. In one or more embodiments, a pipeline impact tool 140, herein referred to as “the tool 140”, is resident within the memory device 106 to facilitate determining the impact on the respective software artifacts in the respective pipeline subsequent to changes to the database schema and/or the data in the database. The tool 140 communicates with the processing device 104 through the communications bus 102.

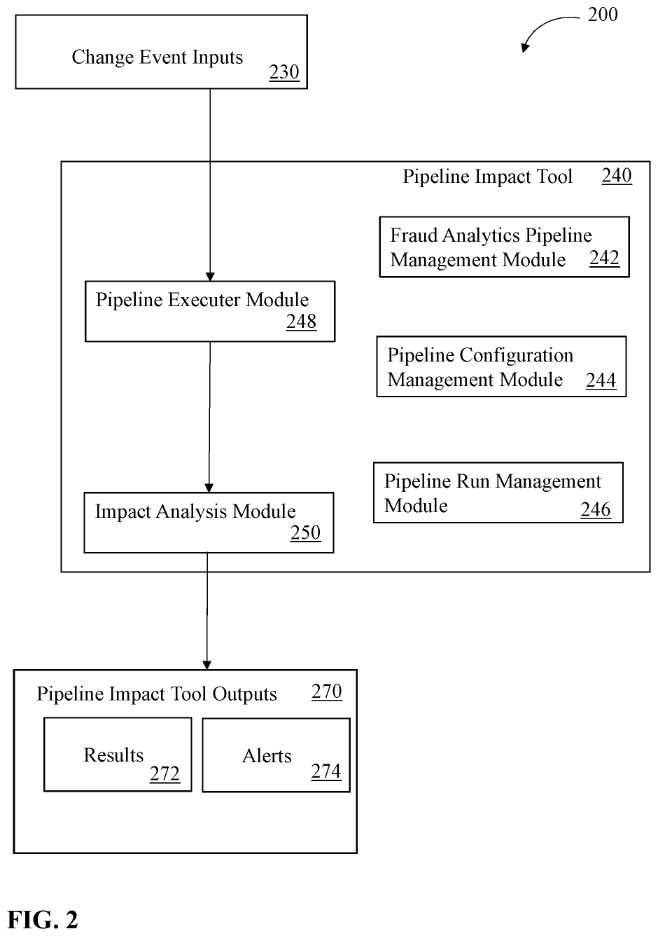

In one or more embodiments, the tool 140 includes a fraud analytics pipeline management module 142, herein referred to as the pipeline management module 142. The tool 140 further includes a pipeline configuration management module 144, a pipeline run management module 146, a pipeline executer module 148, and an impact analysis module 150, where these five components are discussed further with respect to FIG. 2.

In at least some embodiments, the data storage system 108 provides storage to, and without limitation, a knowledge base 190 that includes the data processed through the data analytics pipeline 160, as well as the associated database schema. In addition, the knowledge base 190 includes the results of the data runs through the data analytics pipeline 160, including before and after any changes to the data, the database schema, or the data analytics pipeline 160 itself. In addition, the knowledge base 190 includes the data collected and leveraged by the components in the tool 140 as discussed with respect tot FIG. 2.

Referring to FIG. 2, a block schematic diagram is presented illustrating the relationships between change event inputs 230 to the pipeline impact tool 240, the pipeline impact tool 240, and the outputs 270 of the pipeline impact tool 240, in accordance with some embodiments of the present disclosure.

In some embodiments, the pipeline impact tool 240 (herein referred to as the tool 240) includes a fraud analytics pipeline management module 242 (herein referred to as the pipeline management module 242) that has a dual role, i.e., the pipeline management module 242 is configured to manage the overall processing activities within the data analytics pipeline 160 (shown in FIG. 1) and the pipeline impact tool 240. More specifically, the pipeline management module 242 manages the maintenance of the information associated with, for example, and without limitation, the database schemas, the data within the databases, and the results of the model training, including the associated metadata. In addition, the pipeline management module 242 facilitates optimizing the data runs and reruns through the data analytics pipeline 160 as described herein through management of the other components of the pipeline impact tool 240. In some embodiments, the pipeline management module 242 includes some operational management features reminiscent of an operating system

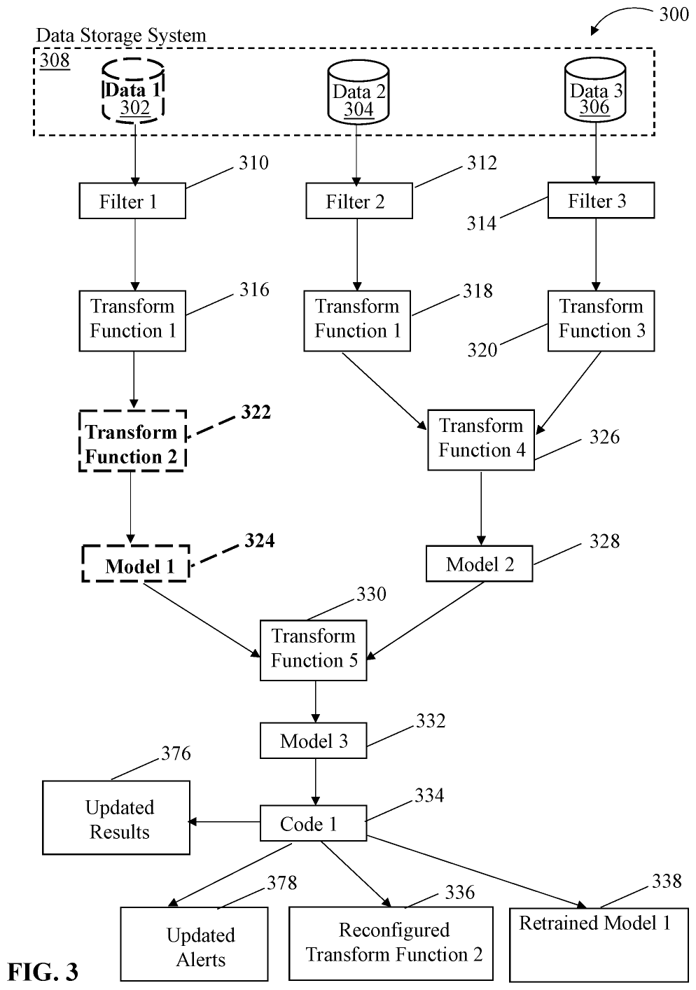

In at least some embodiments, the pipeline management module 242 “understands” the configuration of the components in the data analytics pipeline 160, i.e., the pipeline management module 242 observes the status of each component in the data analytics pipeline 160 and collects data and metadata associated with the operations thereof through the other components in the tool 140. For example, and without limitation, if any of the components in the data analytics pipeline 160, e.g., a transform or model, are experiencing a conflict, the pipeline management module 242 collects the data and metadata associated with the conflict. Moreover, the pipeline management module 242 develops and maintains the results of the pipeline analyses, including alerts. In some embodiments, the pipeline management module 242 is configured to facilitate determinations of those components in the pipeline 160 that will be, or are, impacted by the changes as identified in the change event inputs 230 in conjunction with a pipeline configuration management module 244, a pipeline run management module 246, and an impact analysis module 250 to identify the impact of the change event 230 on the various components in the pipeline 300 (shown in FIG. 3), as discussed further herein. Accordingly, the pipeline management module 242 manages the operation of the other components in the tool 240 and collects the data therefrom.

In at least some embodiments, the pipeline impact tool 240 also includes a pipeline configuration management module 244 that collects and maintains the information with respect to the configuration of the cases to be analyzed through the data analytics pipeline 160 under the direction of the pipeline management module 242. For example, if a particular case has been configured as a JSON, the pipeline configuration management module 244 is configured to identify aspects of the case, including, without limitation, the expected inputs and outputs for the particular case. Accordingly, the pipeline configuration management module 244 operates as a background device with respect to impact analysis.

The pipeline impact tool 240 further includes a pipeline run management module 246 that collects and maintains data and metadata associated with the runtime operation of the data analytics pipeline 160 under the direction of the pipeline management module 242. For example, and without limitation, the dates particular cases were analyzed through the data analytics pipeline 160, the configuration through which the data was run through the data analytics pipeline 160, e.g., the version of the pipeline used (e.g., auto fraud detection version 1), the number of runs executed, and the results generated, including any alerts and/or failure of the analysis. For reruns of the respective cases, the respective data from the pipeline run management module 246 will be referenced by a pipeline executer module 248. Accordingly, the pipeline run management module 246 maintains the statistics associated with the case runs through the data analytics pipeline 160, and as such, operates as a background device with respect to impact analysis.

In one or more embodiments, the pipeline impact tool 240 also includes the pipeline executer module 248 that orchestrates the configuration of the cases analyzed through the data analytics pipeline 160 during runtime under the direction of the pipeline management module 242, including, without limitation, researching various aspects of the cases and executing the analytic tasks one-by-one. The pipeline executer module 248 is configured to call the impact analysis module 250 to determine those portions of the data analytics pipeline 160 (and, only those components) that will need to undergo a rerun of the case and if any of the associated models need to be retrained (both situations discussed further herein) due to the changes in the data. Therefore, the pipeline executer module 248 will also execute the data analytics pipeline 160 during case reruns, and for the impacted tasks, will only rerun those tasks. For those tasks that were not impacted, the pipeline executer module 248 reuses the data and features from the previous run through reference to the pipeline run management module 246.

As previously identified, the pipeline impact tool 240 further includes the impact analysis module 250 that is configured to execute the majority of the actions to automatically determine which steps of the data analytics pipeline 160 will need to undergo a rerun of the case and which models may require retraining. The impact analysis module 250 leverages the information maintained by the pipeline configuration management module 244, the pipeline run management module 246, and the pipeline executer module 248 under the direction of the pipeline management module 242. For example, and without limitation, the impact analysis module 250, for a given change event 230, identifies the changes made to the respective data, and leverages the pipeline configuration management module 244 to identify the impact of the change event 230 on the components of the pipeline 300, and leverages the pipeline run management module 246 to identify the potential alerts that identify a need to rerun the case. In addition, the reconfigurations of the impacted components in the pipeline 300 and the retaining of the impacted models are executed through the impact analysis module 250.

The outputs of the pipeline impact tool 240 include results 272 of the analyses and alerts 274, where the results 272 and alerts 274 facilitate determinations of which components of the pipeline 160 are impacted through the changes.

Referring to FIG. 3, a block schematic diagram is presented illustrating a data analytics pipeline, i.e., the fraud analytics pipeline 300, herein referred to as the pipeline 300, in accordance with some embodiments of the present disclosure. The pipeline 300 is substantially similar to the data analytics pipeline 160 (shown in FIG. 1) and includes a plurality of data sources, i.e., a first data source 302, a second data source 304, and a third data source 306, where the number of three data sources is non-limiting. In some embodiments, the data sources 302, 304, and 306 are separate databases with separate schemas that are resident within the data storage system 308 that is substantially similar to the data storage system 108 (shown in FIG. 1). The first data source 302 includes data 1, the second data source 304 includes data 2, and the third data source 306 includes data 3. The first data source 302 is shown in bolded phantom to illustrate that either a portion of the data 1 or the schema in the first data source 302 has been altered since the last run of the data through the pipeline 300. The change data 1 was changed through either editing of existing data or adding new data, e.g., a new column of data. As discussed further herein, the data 1, data 2, and data 3 include a plurality of data files that are maintained with respect to vehicular insurance claims. Specifically, the data 1 includes vehicular repair data for both active and previous claims, including repair costs, repair vendors, etc. The data 2 includes new claims data for a variety of covered individuals, where such data 2 includes the typical information associated with a vehicular insurance claim. The data 3 includes incident data, e.g., police reports, witness statements, medical reports, etc.

In some embodiments, the data 1, data 2, and data 3 share some data elements, such that each claim from data 2 may also be referred to as a case with the respective data from data 1 and data 3. As discussed further herein, the change to data 1 is the addition of a column to include image data of the respective vehicles before and after the damage cited in the respective claims has been repaired. Data 2 and data 3 remain unchanged since their last run through the pipeline 300. The objective of the pipeline 300 is to score insurance claims, determine the legitimacy of the claims, and then output whether the claims are fraudulent or not.

In some embodiments, the pipeline 300 includes a plurality of components, i.e., software artifacts, or tasks, where the three terms are used interchangeably herein. For example, the pipeline includes a first filter 310, a second filter 312, and a third filter 314. Each of the three filters 310, 312, and 314 are a component of the pipeline 300 in the form of a software artifact that is configured to execute one or more specific tasks. For example, and without limitation, one filter may be configured to remove data from the pipeline's data streams that is inconsequential for the fraud analyses, e.g., minor in-situ windshield repairs, claims less than $100 US, etc. the filters 310, 312, and 314 are configured to be turned “on” and “off” based on user requirements. Accordingly, the data 1 is transmitted through the first filter 310, the data 2 is transmitted through the second filter 312, and the data 3 is transmitted through the third filter 314, where the data not desired for the analyses through the pipeline 300 is filtered out of the respective data streams.

In one or more embodiments, the pipeline 300 includes a plurality of transform functions, where each transform function is configured to transform the remaining data in the respective data streams into a data format for ingestion by the respective subsequent tasks. In some embodiments, each of the transform functions is configured with a narrowly defined functionality to execute predefined tasks that may, or may not, be duplicated in other transform functions for the respective data streams. In some embodiments, the transform functions are configured to intake a file and output a new file with the data transformations. In some embodiments, some of the transform functions are configured to generate statistical data points to facilitate the fraud analyses or configured to generate additional data points for any operation, where the number of additional data points is not limited for the purposes of this disclosure. In some embodiments, additional columns of data are derived from the existing columns of data, for example, and without limitation, determining a difference between two columns of existing data and depositing the difference values into a newly generate third column. In some embodiments, the existing data is reorganized into a more useful configuration, e.g., converting timestamp data into any desired format. In some embodiments, certain rows of data may be filtered or masked temporarily. In some embodiments, the data is mapped as it is transformed from the input format to the output format. In some embodiments, for those portions of a pipeline that require multiple operation on the respective data, a series of transform functions, each with their own unique configurations and tasking, are coupled in series, where such series of trans form functions may impart one or more dependencies on the suite of transform functions in the pipeline. Accordingly, any transform functions that enable operation of the pipeline 300 as described herein are used, where the respective data transformations are executed and transmitted to the respective subsequent tasks.

In the illustrated embodiment, a first instance of a first transform function 316 receives filtered data from the first filter 310, a second instance of the first transfer function 318 receives filtered data from the second filter 312, and a third transform function 320 receives filtered data from the third filter 314 through respective operable and communicative couplings.

As shown in FIG. 3, a second transform function 322 is illustrated in bold phantom to indict that the changes to the data 1 have impacted the second transform function 322. This is contrasted to the first instance of the first transform function 316 that was not impacted by the changes. For example, if the change to data 1 included adding a column for image data, the second transform function 322 may not be configured to operate on such image data. In addition, a first model 324 that is communicatively and operably coupled to the second transform function 322 is also impacted by the added column of image data to data 1, where due to the configuration and the specific task-oriented purpose of the first transform function 316, the additional column of image data is not relevant to the first filter 310 and the first transform function 316, and they are therefore not impacted. Subsequent reconfiguring of the second transform function 322 and retraining of the first model 324 are discussed further herein.

In some embodiments, at least a portion of the models described herein are trained to recognize certain aspects of potentially fraudulent, and non-fraudulent, insurance claims. In some embodiments, the models are configured to score certain aspects of insurance claim cases being run through the pipeline with a confidence factor for the scoring. In some embodiments, at least a portion of the models are arranged in a hierarchical configuration. In some embodiments, the hierarchical configuration of the models facilitates gaining different insights into the claim data from each model that may be assembled into a final determination as to the legitimacy or fraudulency of the respective claims. With respect to changes in the data, some of the models may be impacted, and some models not impacted; however, some of those impacted models in a lower tier of the hierarchy are data inputs to one or more models in an upper tier. Therefore, all of the components, including the models, whether directly impacted by the changes or indirectly impacted due to a relationship with the directly impacted components will automatically be identified as impacted components. Also, in some embodiments, at least some of the models include features that enable automatic retraining thereof as described further herein.

In one or more embodiments, the outputs of the second instance of the first transform function 318 and the third transfer function 320 are transmitted to a fourth transform function 326. Notably, due to the configuration of the inputs to the fourth transform function 326, as well as the tasking of the fourth transform function 326, the outputs of the second instance of the first transform function 318 and the third transfer function 320 are both transformed through the fourth transform function 326. The outputs of the fourth transform function 326 include the merged data from the second instance of the first transform function 318 and the third transfer function 320, and the merged data is transmitted to a second model 328. The outputs of both the first model 324 and the second model 328 are transmitted to a fifth transform function 330, are merged, and the outputs of the fifth transform function 330 are transmitted to a third model 332. The fifth transform function 330 and the third model 332 are not impacted by the change to data 1.

In one or more embodiments, the outputs of the third model 332 are input to the code 334 based on the combined analytic processing of the data 1, data 2, and data 3. The code 334 is previously generated and is resident in the pipeline 300. In some embodiments, the code 334 includes instructions, that when compiled in a runtime environment, present one or more of updated results 376 and updated alerts 378. The updated results 376 present an overall scoring by the third model 332, for example, and without limitation, a score value between 0.0 and 1.0, where the value 0.0 represents no indication of fraudulent behavior in the data 1, data 2, and data 3 and the value 1.0 represents a strong likelihood that one or more fraudulent aspects in the respective claim case have been found. The code 334 may further include instructions, that when compiled in a runtime environment, generate the updated results 376 that include a classification of “low risk of fraud” for those scores between, e.g., and without limitation, 0.0 to 0.3, generate a classification of “moderate risk of fraud” for those scores between 0.3 and 0.7, and generate a classification of “high risk of fraud” for those scores greater than 0.7. The code 334 may also include instructions, that when compiled in a runtime environment, translate the scores in the 0.0 to 1.0 range to a score in a different range such as, and without limitation, 0 to 2000.

In at least some embodiments, the code 334 also includes instructions, that when compiled in a runtime environment, generate updated alerts 378 that include, without limitation, that the updated results 376 may be suspect due to the impacts of the change in data 1 to the second transform function 322 and the first model 324. The updated alerts 378 are configured to precisely identify the tasks in the pipeline 300 that are impacted. Accordingly, those tasks in the pipeline 300 impacted by the changed data 1 will replaced by respective reconfigured tasks that are configured to execute the respective tasks with the changed data 1.

In some embodiments, the system 100 (shown in FIG. 1) includes features that will identify those downstream components in the pipeline 300 that are impacted through configuration changes to any upstream components in the respective data stream. For example, and without limitation, a configuration change to either the first model 324 or the second model 332 may impact the fifth transition function 330 and the third model 332. Accordingly, using the system 100 as described herein, impacts to the tasks within the pipeline 300 through either changes to the input data and the models in the pipeline are determined through running the respective data through the pipeline 300.

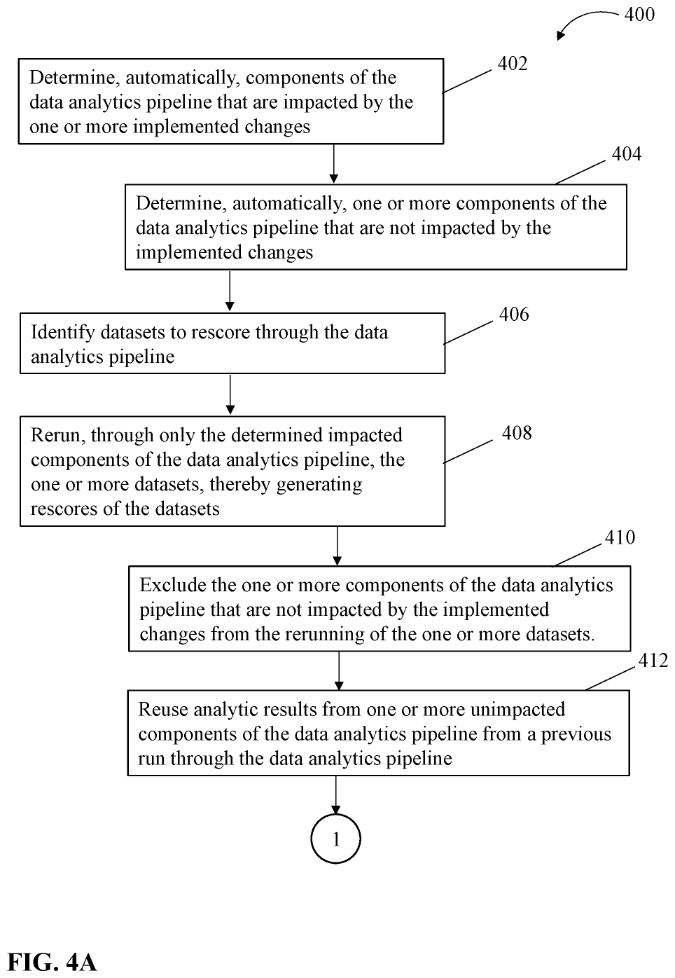

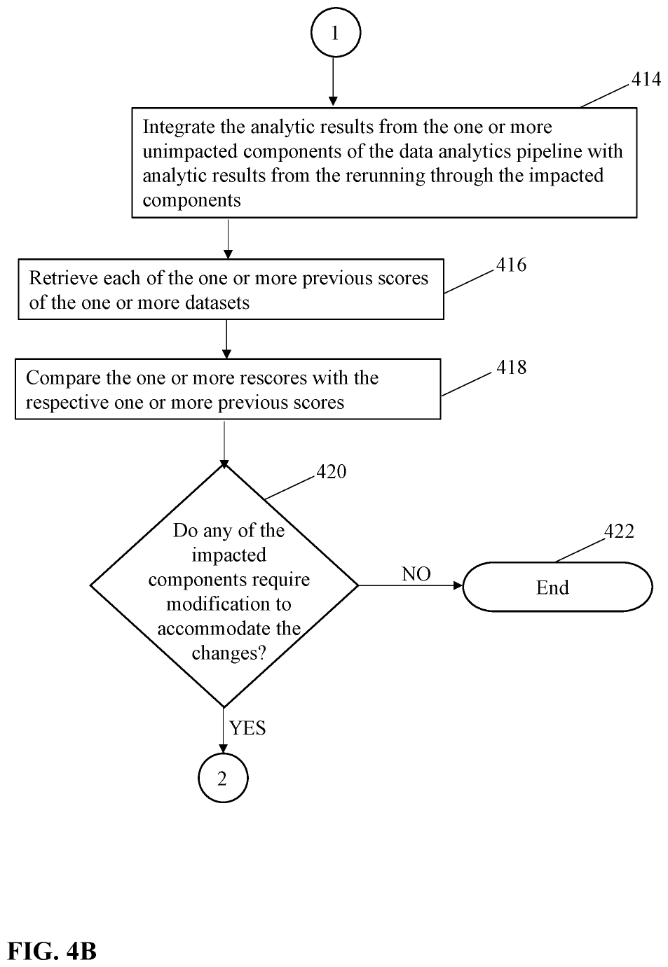

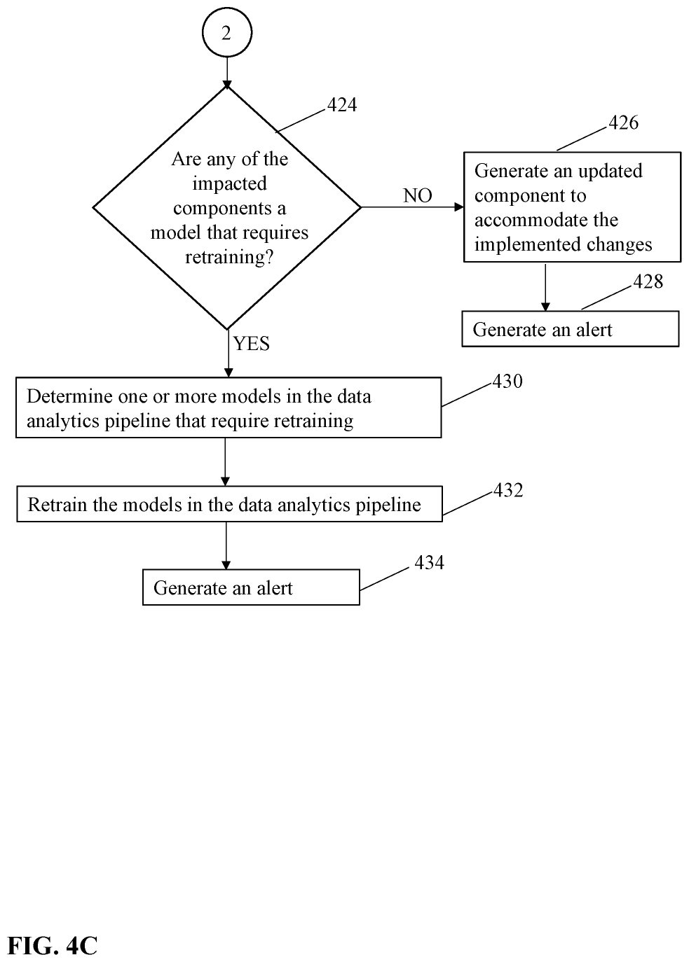

Referring to FIG. 4A, a flowchart is provided illustrating a process 400 for automatically executing an impact analysis of the data analytics pipeline 300 (shown in FIG. 3) to determine impacts to the pipeline 300 subject to changes to one or more of the input data and the pipeline 300, in accordance with some embodiments of the present disclosure. The process 400 includes determining 402, automatically, one or more components of the pipeline 300 that are impacted by one or more implemented changes to the input data, e.g., data 1, data 2, and data 3 (all shown in FIG. 3) and/or the pipeline 300. In at least some embodiments, and also referring to FIG. 2, the impact analysis module 250, in conjunction with the pipeline configuration management module 244, is used to identify the impact of the change event 230. In addition, the impact analysis module 250, in conjunction with the pipeline run management module 246, is used to identify the potential alerts 274. Moreover, the impact analysis module 250 is configured to facilitate determinations of those components in the pipeline 300 that will be, or are, impacted by the changes in the change event inputs 230 as identified by the impact analysis module 250) under the orchestration of the pipeline management module 242. In addition, the determining step 402 also includes determining 404, automatically, through the impact analysis module 250, one or more components of the pipeline 300 that are not impacted by the implemented changes.

In some embodiments, as a portion of the determination steps 402 and 404, the impact analysis module 250 identifies the data that was changed, i.e., data 1, where the changes are in the change event inputs 230. Based on the noted changes, the impact analysis module 250 identifies the impacted and non-impacted tasks of the pipeline 300. As the data 1 is processed and analyzed through the pipeline 300, the first model 324 outputs to the fifth transform function 330, that serially transmits its output to the third model 332, that in turn transmits its outputs to the code 334. Therefore, based on the operations executed by the impact analysis module 250, for a given change event 230, the code 334 generates the updated results 376 and updated alerts 378 that identify those components in the pipeline that are impacted by the change event inputs 230 and identify a need to rerun any cases to determine the effects of the analyses of the data subsequent to the changes. With reference to the example discussed in FIG. 3, the impacted components are the second transform function 322 and the first model 324.

In some embodiments, the process 400 includes identifying 406 one or more datasets to rescore through the pipeline 300. In some embodiments, such identifying step 406 includes making a blanket selection of the datasets of all of the cases that have already been run through the pipeline 300 in any predetermined period of time that enables operation of the system 100 and the tool 240 as described herein, including, e.g., and without limitation, one week. Each of the one or more datasets that include the selected cases to rescore have been scored through the pipeline 300 prior to the one or more changes to the data or the pipeline 300 such that one or more previous scores of each of the one or more respective datasets have been determined by the pipeline 300 prior to the subject changes. Accordingly, the previous datasets run through the pipeline 300 have their respective results 272 and updated results 376 available for subsequent comparisons.

In some embodiments, the identifying step 406 includes selecting predetermined test data for the express purpose of rerunning through the pipeline 300 to test the pipeline 300. In some embodiments, identifying step 406 includes user assistance, and in some embodiments, the identifying step 406 is fully automated to be executed by the tool 240.

In at least some embodiments, the process 400 includes rerunning 408, through only the determined one or more impacted components of the pipeline 300, the identified datasets of cases, thereby generating one or more rescores of the one or more datasets. The pipeline executor module 248 executes the rerunning step 408 based on the impacted components as identified by the impact analysis module 250. The process 400 also includes excluding 410 the one or more components of the data analytics pipeline that are not impacted by the one or more implemented changes from the rerunning of the one or more datasets. The pipeline executor module 248 executes the excluding step 410 based on the components not impacted as identified by the impact analysis module 250. The process 400 further includes reusing 412, through the pipeline executor module 248, analytic results from the one or more unimpacted components of the pipeline 300 from a previous run through the pipeline 300.

Referring to FIG. 4B, a continuation of the flowchart illustrated in FIG. 4A is presented, in accordance with some embodiments of the present disclosure. The process 400 also includes integrating 414 the existing analytic results from the one or more unimpacted components of the pipeline 300 with analytic results from the rerunning 408 of the identified datasets through the impacted components. In one or more embodiments, the process 400 further includes retrieving 416 each of the previous scores of the previously run datasets of cases, and comparing 418 the respective rescores with the respective previous scores to determine the subsequent actions. Subject to the comparing step 418, a determination step 420 includes determining 420 if any of the impacted components require modification to accommodate the identified changes. For a “NO” determination at the determination step 420, the process 400 includes determining that the one or more components of the pipeline 300 that are impacted by the one or more implemented changes require no further action, the updated results 376 are generated (through the code 334) for review by a user, and the process 400 is ended 422

Referring to FIG. 4C, a continuation of the flowchart illustrated in FIG. 4B is presented, in accordance with some embodiments of the present disclosure. For a “YES” determination at the determination step 420, the process 400 proceeds to a determination step 424, where a determination 424 is made with respect to if any of the impacted components of the pipeline 300 require retraining thereof. For a “NO” determination at the determination step 424, the process 400 includes generating 426, by the impact analysis module 250, an updated version of the impacted component to accommodate the implemented changes and generating 428 an updated alert 378 (through the code 334) to notify the user that such an updated version is ready to be placed into production. For a “YES” determination at the determination step 424, the process 400 proceeds to determining 430 (through the impact analysis module 250) the one or more models in the pipeline 300 that require retraining, and automatically retraining 432 (through the impact analysis module 250) the one or more models, including storing the retrained models and generating 434 an updated alert 378 (through the code 334) to notify the user that such a retrained model is ready to be placed into production.

In at least some embodiments, the determination step 430 includes determining that the one or more models are a plurality of models arranged in a hierarchical configuration. For such a situation, it is determined whether a first portion of the plurality of models are directly impacted by the one or more implemented changes, where the first portion of the plurality of models are in a lower tier of the hierarchical configuration. Then, it is determine whether a second portion of the plurality of models are not directly impacted by the one or more implemented changes, where one or more of the second portion of the plurality of models are in a higher tier of the hierarchical configuration. The second portion of the plurality of models is in the higher tier, and receives an output from the first portion of the models in the lower tier of the hierarchical configuration. The second portion of the models in the higher tier are determined to be either indirectly impacted by the one or more implemented changes or determined to be indirectly impacted by the one or more implemented changes, thereby requiring retraining 432.

A system, computer program product, and method are disclosed and described herein for automatically executing an impact analysis of a data analytics pipeline to determine impacts to the pipeline subject to changes to one or more of the input data and the pipeline. In the embodiments described herein, the fraud analytics pipelines only rerun those select tasks that are determined to be impacted by the data changes. For example, and without limitation, the embodiments herein determine whether or not one or more models associated with the subject pipeline need a retraining, or whether or not one or more models associated with the subject pipeline need to be used to rescore the data subsequent to the changes to the database schema or the data therein. Such features as described herein facilitate a significant decrease from the 12-14 hours to completely rerun the data through the pipeline through identifying only those select tasks to rerun. Such a reduction in the time to recover from changes as described herein is critical to complex application pipelines such as, e.g., and without limitation, fraud detection in insurance claims and banking transactions.

Therefore, the embodiments of the data-driven automated model impact analyses disclosed herein provide an improvement to computer technology. For example, the embodiments disclosed herein employ robust mechanisms to distinguish between tasks in a data analytics pipeline that are impacted by the changes and those tasks that are not impacted. Therefore, only those impacted tasks are required to execute a rerun of the respective case data, thereby resulting in a significant decrease of unnecessary processing time and resources such that the respective systems are restored to service substantially sooner that otherwise with known data analytic pipelines.

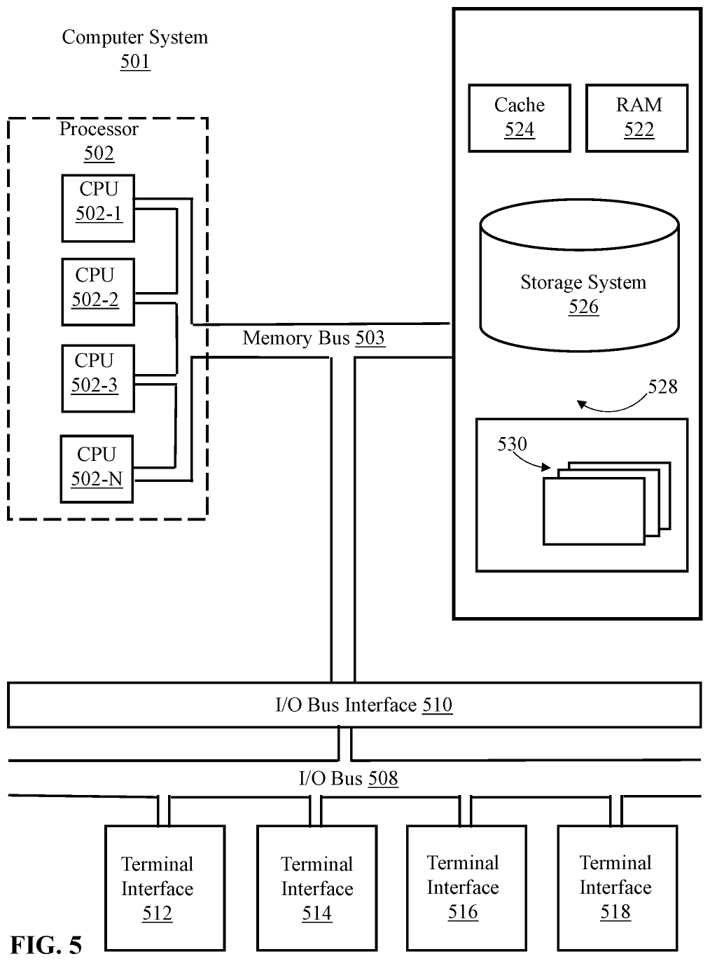

Referring now to FIG. 5, a block schematic diagram is provided illustrating a computing system 501 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 501 may comprise one or more CPUs 502, a memory subsystem 504, a terminal interface 512, a storage interface 516, an I/O (Input/Output) device interface 514, and a network interface 518, all of which may be communicatively coupled, directly or indirectly, for inter-component communication via a memory bus 503, an I/O bus 508, and an I/O bus interface unit 510.

The computer system 501 may contain one or more general-purpose programmable central processing units (CPUs) 502-1, 502-2, 502-3, 502-N, herein collectively referred to as the CPU 502. In some embodiments, the computer system 501 may contain multiple processors typical of a relatively large system; however, in other embodiments the computer system 501 may alternatively be a single CPU system. Each CPU 502 may execute instructions stored in the memory subsystem 504 and may include one or more levels of on-board cache.

System memory 504 may include computer system readable media in the form of volatile memory, such as random access memory (RAM) 522 or cache memory 524. Computer system 501 may further include other removable/non-removable, volatile/non-volatile computer system storage media. By way of example only, storage system 526 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 504 can include flash memory, e.g., a flash memory stick drive or a flash drive. Memory devices can be connected to memory bus 503 by one or more data media interfaces. The memory 504 may include at least one program product having a set (e.g., at least one) of program modules that are configured to carry out the functions of various embodiments.

Although the memory bus 503 is shown in FIG. 5 as a single bus structure providing a direct communication path among the CPUs 502, the memory subsystem 504, and the I/O bus interface 510, the memory bus 503 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 510 and the I/O bus 508 are shown as single respective units, the computer system 501 may, in some embodiments, contain multiple I/O bus interface units 510, multiple I/O buses 508, or both. Further, while multiple I/O interface units are shown, which separate the I/O bus 508 from various communications paths running to the various I/O devices, in other embodiments some or all of the I/O devices may be connected directly to one or more system I/O buses.

In some embodiments, the computer system 501 may be a multi-user mainframe computer system, a single-user system, or a server computer or similar device that has little or no direct user interface, but receives requests from other computer systems (clients). Further, in some embodiments, the computer system 501 may be implemented as a desktop computer, portable computer, laptop or notebook computer, tablet computer, pocket computer, telephone, smart phone, network switches or routers, or any other appropriate type of electronic device.

It is noted that FIG. 5 is intended to depict the representative major components of an exemplary computer system 501. In some embodiments, however, individual components may have greater or lesser complexity than as represented in FIG. 5, components other than or in addition to those shown in FIG. 5 may be present, and the number, type, and configuration of such components may vary.

One or more programs/utilities 528, each having at least one set of program modules 530 may be stored in memory 504. The programs/utilities 528 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 528 and/or program modules 530 generally perform the functions or methodologies of various embodiments.

It is to be understood that although this disclosure includes a detailed description on cloud computing, implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows.

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

A cloud computing environment is service oriented with a focus on statelessness, low coupling, modularity, and semantic interoperability. At the heart of cloud computing is an infrastructure that includes a network of interconnected nodes. The system 501 may be employed in a cloud computing environment.

Referring to FIG. 6, a schematic diagram is provided illustrating a cloud computing environment 650, in accordance with some embodiments of the present disclosure. As shown, cloud computing environment 650 comprises one or more cloud computing nodes 610 with which local computing devices used by cloud consumers, such as, for example, personal digital assistant (PDA) or cellular telephone 654A, desktop computer 654B, laptop computer 654C, and/or automobile computer system 654N may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 650 to offer infrastructure, platforms and/or software as services for which a cloud consumer does not need to maintain resources on a local computing device. It is understood that the types of computing devices 654A-N shown in FIG. 6 are intended to be illustrative only and that computing nodes 610 and cloud computing environment 650 may communicate with any type of computerized device over any type of network and/or network addressable connection (e.g., using a web browser).

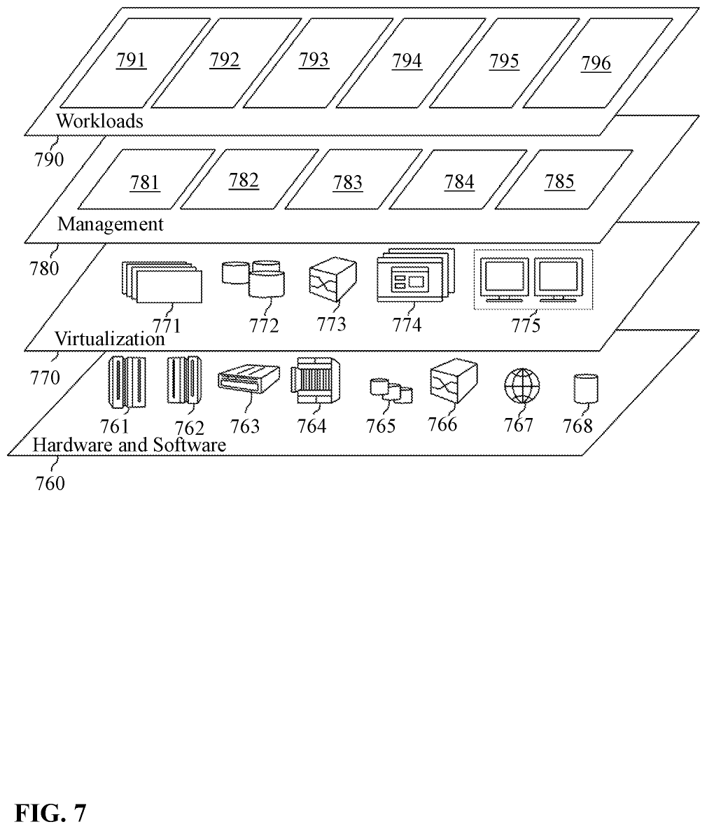

Referring to FIG. 7, a schematic diagram is provided illustrating a set of functional abstraction model layers provided by the cloud computing environment 650 (FIG. 6), in accordance with some embodiments of the present disclosure. It should be understood in advance that the components, layers, and functions shown in FIG. 7 are intended to be illustrative only and embodiments of the disclosure are not limited thereto. As depicted, the following layers and corresponding functions are provided:

Hardware and software layer 760 includes hardware and software components. Examples of hardware components include: mainframes 761; RISC (Reduced Instruction Set Computer) architecture based servers 762; servers 763; blade servers 764; storage devices 765; and networks and networking components 766. In some embodiments, software components include network application server software 767 and database software 768.

Virtualization layer 770 provides an abstraction layer from which the following examples of virtual entities may be provided: virtual servers 771; virtual storage 772; virtual networks 773, including virtual private networks; virtual applications and operating systems 774; and virtual clients 775.

In one example, management layer 780 may provide the functions described below. Resource provisioning 781 provides dynamic procurement of computing resources and other resources that are utilized to perform tasks within the cloud computing environment. Metering and Pricing 782 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 783 provides access to the cloud computing environment for consumers and system administrators. Service level management 784 provides cloud computing resource allocation and management such that required service levels are met. Service Level Agreement (SLA) planning and fulfillment 785 provide pre-arrangement for, and procurement of, cloud computing resources for which a future requirement is anticipated in accordance with an SLA.

Workloads layer 790 provides examples of functionality for which the cloud computing environment may be utilized. Examples of workloads and functions which may be provided from this layer include: mapping and navigation 791; software development and lifecycle management 792; layout detection 793; data analytics processing 794; transaction processing 795; and automatically executing an impact analysis of a data analytics pipeline to determine impacts to the pipeline subject to changes to one or more of the input data and the pipeline 796.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system for automatically executing an impact analysis of a data analytics pipeline to determine impacts to the data analytics pipeline subject to implemented changes to one or more of input data and the data analytics pipeline, the computer system comprising:
one or more processing devices;
one or more memory devices communicatively and operably coupled to the one or more processing devices;
a pipeline impact tool at least partially embedded within the one or more memory devices, the pipeline impact tool is configured to:
determine, automatically, one or more components of the data analytics pipeline that are impacted by the one or more implemented changes;
identify one or more datasets to rescore through the data analytics pipeline, wherein each of the one or more datasets to rescore have been scored through the data analytics pipeline prior to the one or more implemented changes such that one or more previous scores of each of the one or more respective datasets have been determined by the data analytics pipeline prior to the one or more implemented changes;
rerun, through only the determined one or more impacted components of the data analytics pipeline, the one or more datasets, thereby generating one or more rescores of the one or more datasets;
retrieve each of the one or more previous scores of the one or more datasets;
compare the one or more rescores with the respective one or more previous scores; and
transmit, subject to the comparing, one or more alerts to an output device.

2. The system of claim 1, wherein the pipeline impact tool is further configured to:
reuse analytic results from one or more unimpacted components of the data analytics pipeline from a previous run through the data analytics pipeline; and
integrate the analytic results from the one or more unimpacted components of the data analytics pipeline with analytic results from the rerunning.

3. The system of claim 1, wherein the pipeline impact tool is further configured to:
determine one or more models in the data analytics pipeline requiring retraining.

4. The system of claim 3, wherein the pipeline impact tool is further configured to:
retrain, automatically, the one or more models.

5. The system of claim 3, wherein the one or more models are a plurality of models arranged in a hierarchical configuration, the pipeline impact tool is further configured to:
determine that a first portion of the plurality of models are directly impacted by the one or more implemented changes, where one or more models of the first portion of the plurality of models are in a lower tier of the hierarchical configuration;
determine that a second portion of the plurality of models are not directly impacted by the one or more implemented changes, where one or more models of the second portion of the plurality of models are in a higher tier of the hierarchical configuration, wherein the one or more models of the second portion of the plurality of models in the higher tier receive an output from one or more of models of the first portion of the plurality of models in the lower tier of the hierarchical configuration;
determine the one or more models of the second portion of the plurality of models in the higher tier are indirectly impacted by the one or more implemented changes; and
determine the one or more models of the second portion of the plurality of models in the higher tier indirectly impacted by the one or more implemented changes require the retraining.

6. The system of claim 1, wherein the pipeline impact tool is further configured to:
determine, automatically, one or more components of the data analytics pipeline that are not impacted by the one or more implemented changes; and
exclude the one or more components of the data analytics pipeline that are not impacted by the one or more implemented changes from the rerunning of the one or more datasets.

7. The system of claim 1, wherein the pipeline impact tool is further configured to:
determine that the one or more components of the data analytics pipeline that are impacted by the one or more implemented changes require no further action.

8. A computer program product embodied on at least one computer readable storage medium having computer executable instructions for automatically executing an impact analysis of a data analytics pipeline to determine impacts to the data analytics pipeline subject to implemented changes to one or more of input data and the data analytics pipeline that when executed cause one or more computing devices to:
determine, automatically, one or more components of the data analytics pipeline that are impacted by the one or more implemented changes;
identify one or more datasets to rescore through the data analytics pipeline, wherein each of the one or more datasets to rescore have been scored through the data analytics pipeline prior to the one or more implemented changes such that one or more previous scores of each of the one or more respective datasets have been determined by the data analytics pipeline prior to the one or more implemented changes;
rerun, through only the determined one or more impacted components of the data analytics pipeline, the one or more datasets, thereby generating one or more rescores of the one or more datasets;
retrieve each of the one or more previous scores of the one or more datasets;
compare the one or more rescores with the respective one or more previous scores; and
transmit, subject to the comparison, one or more alerts to an output device.

9. The computer program product of claim 8, further having computer executable instructions to:
reuse analytic results from one or more unimpacted components of the data analytics pipeline from a previous run through the data analytics pipeline; and
integrate the analytic results from the one or more unimpacted components of the data analytics pipeline with analytic results from the rerunning.

10. The computer program product of claim 8, further having computer executable instructions to:
determine one or more models in the data analytics pipeline requiring the retraining; and
retrain, automatically, the one or more models.

11. The computer program product of claim 10, further having computer executable instructions to:
determine that a first portion of the plurality of models are directly impacted by the one or more implemented changes, where one or more models of the first portion of the plurality of models are in a lower tier of the hierarchical configuration;
determine that a second portion of the plurality of models are not directly impacted by the one or more implemented changes, where one or more models of the second portion of the plurality of models are in a higher tier of the hierarchical configuration, wherein the one or more models of the second portion of the plurality of models in the higher tier receive an output from one or more of models of the first portion of the plurality of models in the lower tier of the hierarchical configuration;
determine the one or more models of the second portion of the plurality of models in the higher tier are indirectly impacted by the one or more implemented changes; and
determine the one or more models of the second portion of the plurality of models in the higher tier indirectly impacted by the one or more implemented changes require the retraining.

12. The computer program product of claim 8, further having computer executable instructions to:
determine, automatically, one or more components of the data analytics pipeline that are not impacted by the one or more implemented changes; and
exclude the one or more components of the data analytics pipeline that are not impacted by the one or more implemented changes from the rerunning of the one or more datasets.

13. The computer program product of claim 8, further having computer executable instructions to:
determine that the one or more components of the data analytics pipeline that are impacted by the one or more implemented changes require no further action.

14. A computer-implemented method for automatically executing an impact analysis of a data analytics pipeline to determine impacts to the data analytics pipeline subject to implemented changes to one or more of input data and the data analytics pipeline, the method comprising:
determining, automatically, one or more components of the data analytics pipeline that are impacted by the one or more implemented changes;
identifying one or more datasets to rescore through the data analytics pipeline, wherein each of the one or more datasets to rescore have been scored through the data analytics pipeline prior to the one or more implemented changes such that one or more previous scores of each of the one or more respective datasets have been determined by the data analytics pipeline prior to the one or more implemented changes;
rerunning, through only the determined one or more impacted components of the data analytics pipeline, the one or more datasets, thereby generating one or more rescores of the one or more datasets;
retrieving each of the one or more previous scores of the one or more datasets;
comparing the one or more rescores with the respective one or more previous scores; and
transmitting, subject to the comparing, one or more alerts to an output device.

15. The method of claim 14, wherein the rerunning the one or more datasets comprises:
reusing analytic results from one or more unimpacted components of the data analytics pipeline from a previous run through the data analytics pipeline; and
integrating the analytic results from the one or more unimpacted components of the data analytics pipeline with analytic results from the rerunning.

16. The method of claim 14, further comprising:
determining one or more models in the data analytics pipeline requiring retraining.

17. The method of claim 16, further comprising:
retraining, automatically, the one or more models.

18. The method of claim 16, wherein the one or more models are a plurality of models arranged in a hierarchical configuration, the determining one or more models in the data analytics pipeline requiring the retraining comprises:
determining that a first portion of the plurality of models are directly impacted by the one or more implemented changes, where one or more models of the first portion of the plurality of models are in a lower tier of the hierarchical configuration;
determining that a second portion of the plurality of models are not directly impacted by the one or more implemented changes, where one or more models of the second portion of the plurality of models are in a higher tier of the hierarchical configuration, wherein the one or more models of the second portion of the plurality of models in the higher tier receive an output from one or more models of the first portion of the plurality of models in the lower tier of the hierarchical configuration;
determining the one or more models of the second portion of the plurality of models in the higher tier are indirectly impacted by the one or more implemented changes; and
determining the one or more models of the second portion of the plurality of models in the higher tier indirectly impacted by the one or more implemented changes require the retraining.

19. The method of claim 14, further comprising:
determining, automatically, one or more components of the data analytics pipeline that are not impacted by the one or more implemented changes; and
excluding the one or more components of the data analytics pipeline that are not impacted by the one or more implemented changes from the rerunning of the one or more datasets.

20. The method of claim 14, wherein the comparing the one or more rescores with the respective one or more previous scores comprises:
determining that the one or more components of the data analytics pipeline that are impacted by the one or more implemented changes require no further action.
